(19) United States
(12) Patent Application Publication
(10) Pub. No.: US 2024/0149215 A1
(43) Pub. Date: May 9, 2024

(54) CARBON DIOXIDE RECOVERY SYSTEM

(71) Applicant: DENSO CORPORATION, Kariya-city (JP)

(72) Inventors: Eiichi HIROSE, Kariya-city (JP); Hironori TATSUMI, Kariya-city (JP); Hiroki TAKEZAKI, Kariya-city (JP)

(21) Appl. No.: 18/403,494

(22) Filed: Jan. 3, 2024

Related U.S. Application Data
(63) Continuation of application No. PCT/JP2022/033875, filed on Sep. 9, 2022.

(30) Foreign Application Priority Data
Sep. 21, 2021 (JP) 2021-153163

(51) Int. Cl. B01D 53/32; B01D 53/62; C01B 32/50

(52) U.S. Cl. CPC B01D 53/326; B01D 53/62; C01B 32/50; B01D 2257/504; B01D 2258/01; B01D 2258/06

(57) ABSTRACT

A carbon dioxide recovery system separates CO₂ from a CO₂ containing gas containing CO₂ by an electrochemical reaction. The carbon dioxide recovery system includes an electrochemical cell having a working electrode and a counter electrode. The working electrode has a CO₂ adsorbent that adsorbs CO₂. When electrons are supplied from the counter electrode to the working electrode by applying a voltage between the working electrode and the counter electrode, the CO₂ adsorbent combines with CO₂ as the electrons are supplied. The working electrode has a working electrode conductive additive that forms a conductive path to the CO₂ adsorbent. The working electrode conductive additive is a metal oxide having a structure in which an oxygen element is disposed around a metal element.

### CROSS REFERENCE TO RELATED APPLICATIONS

The present application is a continuation application of International Patent Application No. PCT/JP2022/033875 filed on Sep. 9, 2022, which designated the U.S. and claims the benefit of priority from Japanese Patent Application No. 2021-153163 filed on Sep. 21, 2021. The entire disclosures of all of the above applications are incorporated herein by reference.

### TECHNICAL FIELD

The present disclosure relates to a carbon dioxide recovery system that recover CO₂ from CO₂ containing gas.

### BACKGROUND

A gas separation system separates CO₂ from a CO₂ containing gas by an electrochemical reaction. The gas separation system includes an electrochemical cell having an electrode.

### SUMMARY

According to an aspect of the present disclosure, a carbon dioxide recovery system for separating CO₂ from a CO₂ containing gas containing CO₂ by an electrochemical reaction includes an electrochemical cell. The electrochemical cell includes a working electrode having a CO₂ adsorbent that adsorbs CO₂, and a counter electrode. In the electrochemical cell, when a voltage is applied between the working electrode and the counter electrode, electrons are supplied from the counter electrode to the working electrode, and the CO₂ adsorbent combines with CO₂ as the electrons are supplied.

### BRIEF DESCRIPTION OF DRAWINGS

The above and other objects, features and advantages of the present disclosure will be more clearly understood from the following detailed description with reference to the accompanying drawings. In the accompanying drawings:

FIG. 1 is a diagram illustrating a carbon dioxide recovery system according to a first embodiment;

FIG. 2 is a diagram illustrating a CO₂ recovery device;

FIG. 3 is a cross-sectional view of an electrochemical cell;

FIG. 4 is a diagram illustrating CO₂ selective permeability and hydrophobicity of a negative electrode binder;

FIG. 5 is an enlarged sectional view illustrating a surface of a negative electrode of the electrochemical cell;

FIG. 6 is a diagram illustrating a CO₂ recovery mode and a CO₂ release mode of the CO₂ recovery device;

FIG. 7 is a diagram showing a reaction between a working electrode conductive additive, which is a metal oxide, and O²⁻;

FIG. 8 is a diagram showing a reaction between a working electrode conductive additive, which is a carbon material, and O²⁻ as a comparative example;

FIG. 9 is a diagram showing a decomposition reaction of polyvinylferrocene in a second embodiment;

FIG. 10 is a diagram showing a molecular structure of decamethylferrocene according to the second embodiment;

FIG. 11 is a diagram showing a molecular structure of phenothiazine in a third embodiment;

FIG. 12 is a diagram showing a molecular structure of phenoxazine according to the third embodiment;

FIG. 13 is a diagram showing a molecular structure of methylphenothiazine according to the third embodiment; and

FIG. 14 is a diagram showing a molecular structure of phenylphenothiazine according to the third embodiment.

### DETAILED DESCRIPTION

Conventionally, a gas separation system has been proposed to separate CO₂ from a CO₂ containing gas by an electrochemical reaction. The gas separation system includes an electrochemical cell having an electrode. For the electrode, a carbonaceous material such as carbon nanotube, carbon black, Ketjen black, carbon black, or graphene, or a material containing carbon such as polyanthraquinone or polyvinylferrocene is used.

However, in the above-described conventional technique, since the electrode containing carbon is in contact with atmospheric air, a reaction occurs between a substance containing oxygen such as H₂O or O₂ in the atmosphere and the electrode. Therefore, an organic gas is generated.

The generation of the organic gas reduces the recovery purity of CO₂. Since the recovery purity of CO₂ decreases with respect to the energy used for recovering CO₂, the energy efficiency decreases. Furthermore, since the electrode is consumed by the reaction between the substance containing oxygen and the electrode, the repetitive durability of the electrode decreases.

The present disclosure provides a carbon dioxide recovery system capable of suppressing generation of an organic gas caused by a reaction between a substance containing oxygen and an electrode.

According to the first, second, and third aspects of the present disclosure, a carbon dioxide recovery system for separating CO₂ from a CO₂ containing gas containing CO₂ by an electrochemical reaction includes an electrochemical cell.

The electrochemical cell includes a working electrode having a CO₂ adsorbent that adsorbs CO₂, and a counter electrode. In the electrochemical cell, when a voltage is applied between the working electrode and the counter electrode, electrons are supplied from the counter electrode to the working electrode, and the CO₂ adsorbent combines with CO₂ as the electrons are supplied.

In the first aspect, the working electrode includes a working electrode conductive additive that forms a conductive path to the CO₂ adsorbent. The working electrode conductive additive is a metal oxide having a structure in which an oxygen element is disposed around a metal element.

Accordingly, since the working electrode conductive additive is a metal oxide containing no carbon, a reaction between a substance containing oxygen in the CO₂ containing gas and the working electrode conductive additive does not occur. Therefore, the generation of organic gas can be suppressed.

In the second aspect, the counter electrode includes a counter electrode active material that emits electrons when a voltage is applied between the working electrode and the counter electrode. The counter electrode active material is a substance in which the sulfur element is substituted with an element different from the sulfur element in the heterocyclic compound in which benzene rings are fused at both ends of thiazine containing the sulfur element and the nitrogen element. Alternatively, the counter electrode active material is a substance in which a functional group is modified with a nitrogen element in the heterocyclic compound.

In the heterocyclic compound, the sulfur element and the nitrogen element are likely to react with a substance containing oxygen. However, the structural stability of the counter electrode active material can be enhanced by replacing the sulfur element in the heterocyclic compound with an element different from the sulfur element or modifying the functional group to the nitrogen element in the heterocyclic compound. Therefore, it is possible to suppress the reaction between the substance containing oxygen in the CO₂ containing gas and the counter electrode active material. Therefore, the generation of organic gas can be suppressed.

In the third aspect, the counter electrode includes a counter electrode active material that emits electrons when a voltage is applied between the working electrode and the counter electrode. The counter electrode active material is a substance in which a functional group is modified at the apex of a five-membered ring constituting a cyclopentadienyl metal complex.

According to this, since the functional group becomes steric hindrance, it is difficult for the substance containing oxygen to approach the metal element constituting the cyclopentadienyl metal complex. Therefore, the decomposition reaction of the cyclopentadienyl metal complex by the substance containing oxygen is suppressed. Therefore, the generation of organic gas can be suppressed.

The following will describe embodiments for carrying out the present disclosure with reference to the drawings. In each embodiment, portions corresponding to those described in the preceding embodiment are denoted by the same reference numerals, and overlapping descriptions may be omitted. In a case where only a part of a configuration is described in each embodiment, the other embodiments described above are capable of being applied for the other parts of the configuration. A combination of parts is possible when it is explicitly stated that the combination is possible in each embodiment. A partial combination of the embodiments is also possible even if it is not explicitly stated that the partial combination is possible, unless there is a particular problem with the partial combination.

### First Embodiment

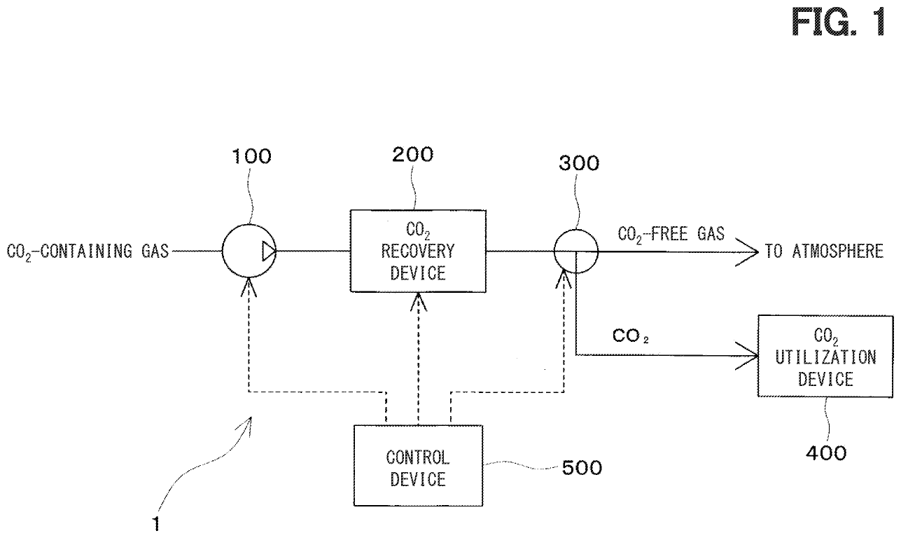

A carbon dioxide recovery system according to the present embodiment separates CO₂ from a CO₂ containing gas containing CO₂ by an electrochemical reaction. As shown in FIG. 1, the carbon dioxide recovery system 1 includes a compressor 100, a CO₂ recovery device 200, a flow path switching valve 300, a CO₂ utilization device 400, and a control device 500.

The compressor 100 pumps CO₂ containing gas to the CO₂ recovery device 200. The CO₂ containing gas is a mixed gas containing CO₂ and a gas other than CO₂. The CO₂ containing gas is, for example, atmospheric gas or an exhaust gas of an internal combustion engine.

The CO₂ recovery device 200 separates and recovers CO₂ from the CO₂ containing gas. The CO₂ recovery device 200 discharges CO₂-free gas after CO₂ is recovered from the CO₂ containing gas, or CO₂ recovered from the CO₂ containing gas.

The flow path switching valve 300 is a three-way valve that switches a passage of gas discharged from the CO₂ recovery device 200. When the CO₂-free gas is discharged from the CO₂ recovery device 200, the flow path switching valve 300 switches the flow path of the gas to the atmosphere. When CO₂ is discharged from the CO₂ recovery device 200, the flow path switching valve 300 switches the flow path of the gas to the CO₂ utilization device 400.

The CO₂ utilization device 400 utilizes CO₂. The CO₂ utilization device 400 may be a storage tank for storing CO₂ or a conversion device for converting CO₂ into fuel. As the conversion device, a device that converts CO₂ into a hydrocarbon fuel such as methane can be used. The hydrocarbon fuel may be a gaseous fuel at room temperature and atmospheric pressure, or may be a liquid fuel at room temperature and atmospheric pressure.

The control device 500 includes a well-known microcomputer including a CPU, a ROM, a RAM, and the like, and peripheral circuits thereof. The control device 500 performs various calculations and processes in accordance with a control program stored in the ROM. In addition, the control device 500 controls the compressor 100, the CO₂ recovery device 200, the flow path switching of the flow path switching valve 300, and the like.

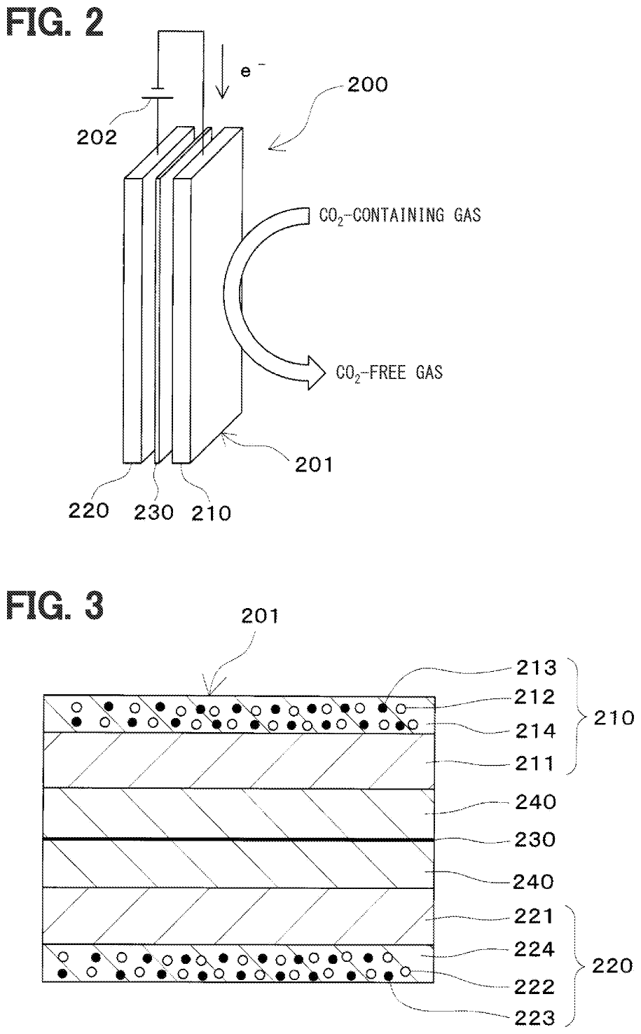

Next, a specific configuration of the CO₂ recovery device 200 will be described. As shown in FIGS. 2 and 3, the CO₂ recovery device 200 includes an electrochemical cell 201. The electrochemical cell 201 includes a working electrode 210, a counter electrode 220, an insulating layer 230, and an ion conductive member 240.

FIG. 2 illustrates an example in which the working electrode 210, the counter electrode 220, and the insulating layer 230 are each configured in a plate shape. In FIG. 2, the working electrode 210, the counter electrode 220, and the insulating layer 230 are arranged at intervals, but these components are actually arranged so as to be in contact with each other.

The electrochemical cell 201 may be housed in a container (not shown). The container may be provided with a gas inlet through which the CO₂ containing gas flows into the container and a gas outlet through which the CO₂-free gas or CO₂ flows out of the container.

The CO₂ recovery device 200 adsorbs and desorbs CO₂ by an electrochemical reaction, and separates and recovers CO₂ from the CO₂ containing gas. The CO₂ recovery device 200 includes a power supply 202 that applies a predetermined voltage to the working electrode 210 and the counter electrode 220. The power supply 202 can change a potential difference between the working electrode 210 and the counter electrode 220. The working electrode 210 is a negative electrode. The counter electrode 220 is a positive electrode.

The electrochemical cell 201 can operate by switching between a CO₂ recovery mode in which CO₂ is recovered by the working electrode 210 and a CO₂ release mode in which CO₂ is released from the working electrode 210. When the potential difference between the working electrode 210 and the counter electrode 220 changes, the CO₂ recovery mode and the CO₂ release mode are switched. The CO₂ recovery mode is a charging mode in which the electrochemical cell 201 is charged. The CO₂ release mode is a discharge mode in which the electrochemical cell 201 is discharged.

In the CO₂ recovery mode, a first voltage is applied between the working electrode 210 and the counter electrode 220. Thus, electrons are supplied from the counter electrode 220 to the working electrode 210. At the first voltage, the working electrode potential is less than the counter electrode potential. The first voltage may be, for example, within a range of 0.5 V to 2.0 V.

In the CO₂ release mode, a second voltage lower than the first voltage is applied between the working electrode 210 and the counter electrode 220. Thus, electrons are supplied from the working electrode 210 to the counter electrode 220. The second voltage may be lower than the first voltage, and the magnitude relationship between the working electrode potential and the counter electrode potential is not limited. That is, in the CO₂ release mode, the working electrode potential may be smaller than the counter electrode potential, may be equal to the counter electrode potential, or may be layer than the counter electrode potential.

As shown in FIG. 3, the working electrode 210 includes a working electrode base material 211, a CO₂ adsorbent 212, a working electrode conductive additive 213, and a working electrode binder 214. In FIG. 3, for the sake of convenience, the CO₂ adsorbent 212, the working electrode conductive additive 213, and the working electrode binder 214 are shown to be located outside the working electrode base material 211. Actually, the CO₂ adsorbent 212, the working electrode conductive additive 213, and the working electrode binder 214 are provided inside the porous working electrode base material 211.

The working electrode base material 211 is a porous conductive material through which CO₂ can pass. As the working electrode base material 211, for example, a carbonaceous material or a metal material can be used. The carbonaceous material constituting the working electrode base material 211 may be, for example, carbon paper, carbon cloth, non-woven carbon mat, porous gas diffusion layer (GDL) and the like. As the metal material constituting the working electrode base material 211, for example, a structure in which a metal such as Al or Ni is formed into a mesh shape can be used.

The CO₂ adsorbent 212 has redox activity and is an electroactive species capable of reversibly causing an oxidation-reduction reaction. The CO₂ adsorbent 212 can bind and adsorb CO₂ in a reduced state, and can release CO₂ in an oxidized state.

The CO₂ adsorbent 212 has a functional group that binds to CO₂. The functional group bonded to CO₂ exchanges electrons and becomes a CO₂ adsorption site. Examples of the functional group that binds to CO₂ include a functional group containing an element having high electronegativity, such as F, O, N, Cl, or S. As the functional group bonded to CO₂, for example, a ketone group (C═O) can be used.

In the present embodiment, the CO₂ adsorbent 212 is polyanthraquinone, which is an organic polymer having a ketone group. As the polyanthraquinone, poly-(1,4-anthraquinone), poly-(1,5-anthraquinone), poly-(1,8-anthraquinone), poly-(2,6-anthraquinone), or the like can be used. In the present embodiment, poly-(1,4-anthraquinone) shown below is used as the CO₂ adsorbent 212.

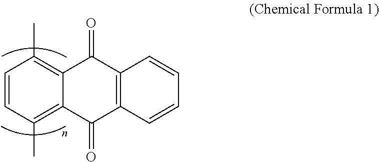

The working electrode conductive additive 213 is a conductive material that forms a conductive path to the CO₂ adsorbent 212. The working electrode conductive additive 213 is used by being mixed with the CO₂ adsorbent 212. In FIG. 3, the working electrode conductive additive 213 is illustrated as being separated from the CO₂ adsorbent 212, but the working electrode conductive additive 213 is actually in contact with the CO₂ adsorbent 212.

The mixing of the CO₂ adsorbent 212 and the working electrode conductive additive 213 may be performed by dissolving the working electrode conductive additive 213 in an organic solvent such as NMP (N-methylpyrrolidone) and bringing the working electrode conductive additive 213 dispersed in the organic solvent into contact with the CO₂ adsorbent 212. The contact between the working electrode conductive additive 213 and the CO₂ adsorbent 212 can be performed by a method in which the working electrode base material 211 including the CO₂ adsorbent 212 is immersed in a solvent in which the working electrode conductive additive 213 is dispersed, and dip coating is performed, or the like. Accordingly, the working electrode conductive additive 213 can be uniformly brought into contact with the CO₂ adsorbent 212.

The working electrode conductive additive 213 is a metal oxide having a structure in which an oxygen element is disposed around a metal element. The metal oxide is a stable conductive additive that does not undergo a chemical reaction other than a main reaction with a gas species other than CO₂ in the atmosphere. The metal oxide is a stable conductive additive that does not undergo a chemical reaction other than a main reaction with the electrode members other than the working electrode conductive additive 213 in the working electrode 210. The main reaction means that, in the electrochemical cell 201, when a voltage is applied between the working electrode 210 and the counter electrode 220, electrons are supplied from the counter electrode 220 to the working electrode 210, and the CO₂ adsorbent 212 combines with CO₂ as the electrons are supplied.

Examples of the metal element include Sc, Ti, V, Cr, Mn, Fe, Co, Ni, and Cu. Alternatively, the metal element is, for example, Y, Zr, Nb, Mo, Tc, Ru, Rh, Pd, or Ag. Alternatively, the metal element is, for example, La, Ce, Pr, Nd, Pm, Sm, Eu, Gd, Tb, Dy, Ho, Er, Tm, Yb, Lu, Hf, Ta, W, Re, Os, Ir, Pt, or Au. The metal oxide is, for example, ruthenium oxide or manganese dioxide. The working electrode conductive additive 213 is, for example, in the form of particles.

The working electrode binder 214 is a holding material for holding the CO₂ adsorbent 212 and the working electrode conductive additive 213 on the working electrode base material 211. The working electrode binder 214 has an adhesive force. The working electrode binder 214 holds the CO₂ adsorbent 212 and the working electrode conductive additive 213 on the working electrode base material 211. Accordingly, it is possible to secure the transfer of electrons among the working electrode base material 211, the CO₂ adsorbent 212, and the working electrode conductive additive 213. In addition, the CO₂ adsorbent 212 is less likely to be peeled off from the working electrode base material 211, and a decrease in the amount of CO₂ adsorbed by the electrochemical cell 201 over time can be suppressed.

The working electrode binder 214 may be a conductive material having conductivity. Accordingly, it is possible to restrict the working electrode binder 214 from inhibiting the flow of electrons between the working electrode base material 211 and the CO₂ adsorbent 212.

In the present embodiment, a mixture of the CO₂ adsorbent 212, the working electrode conductive additive 213, and the working electrode binder 214 is formed, and this mixture is bonded to the working electrode base material 211. The CO₂ adsorbent 212 and the working electrode conductive additive 213 are held inside the working electrode binder 214. Therefore, the working electrode binder 214 can firmly hold the CO₂ adsorbent 212 and the working electrode conductive additive 213. In addition, the CO₂ adsorbent 212 and the working electrode conductive additive 213 are less likely to be peeled off from the working electrode base material 211.

The working electrode binder 214 has a CO₂ permeability capable of permeating CO₂. Further, the working electrode binder 214 has CO₂ selective permeability capable of selectively permeating CO₂ among a plurality of types of gases contained in the CO₂ containing gas. In addition, the working electrode binder 214 has hydrophobicity.

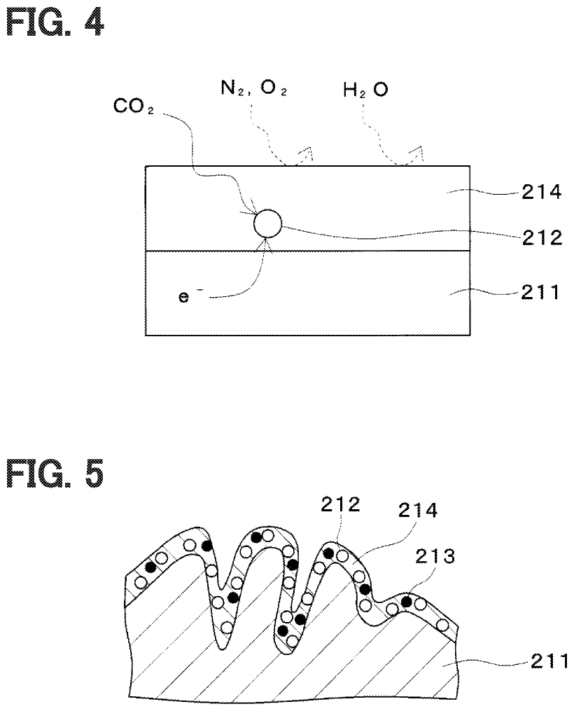

As shown in FIG. 4, CO₂ contained in the CO₂ containing gas can pass through the working electrode binder 214 and reach the CO₂ adsorbent 212 located inside the working electrode binder 214. That is, even when the CO₂ containing gas cannot directly contact the CO₂ adsorbent 212, the CO₂ can pass through the working electrode binder 214 and reach the CO₂ adsorbent 212. Therefore, even when the CO₂ adsorbent 212 is located inside the working electrode binder 214, CO₂ can be recovered by the CO₂ adsorbent 212.

In contrast, gases other than CO₂, such as N₂ and O₂, contained in the CO₂ containing gas cannot pass through the working electrode binder 214 having CO₂ selective permeability. Therefore, it is possible to suppress the gas other than CO₂ contained in the CO₂ containing gas from reaching the working electrode binder 214. Therefore, the concentration of CO₂ reaching the CO₂ adsorbent 212 can be increased. In addition, the amount of CO₂ adsorbed by the CO₂ adsorbent 212 can be increased.

Further, when moisture (H₂O) is contained in the CO₂ containing gas, the moisture does not permeate into the working electrode binder 214 having hydrophobicity. Therefore, even in the presence of moisture (H₂O), it is possible to suppress the H₂O from reaching the working electrode binder 214. Accordingly, it is possible to prevent H₂O from preferentially reacting with the CO₂ adsorbent 212, and it is possible to increase the amount of CO₂ adsorbed by the CO₂ adsorbent 212.

As the working electrode binder 214, a non-fluid substance having no fluidity can be used. Examples of the non-fluid substance include a gel substance and a solid substance. As the gel substance, for example, an ionic liquid gel can be used. As the solid substance, for example, a solid electrolyte, a conductive resin, or the like can be used.

When a solid electrolyte is used as the working electrode binder 214, it is desirable to use an ionomer made of a polymer electrolyte or the like in order to increase the contact area with the CO₂ adsorbent 212. When a conductive resin is used as the working electrode binder 214, an epoxy resin containing Ag or the like, a fluororesin such as polytetrafluoroethylene (PTFE) or polyvinylidene fluoride (PVDF), or the like can be used as the conductive filler.

The raw material of the working electrode binder 214 may be a liquid substance having fluidity. In this case, the CO₂ adsorbent 212 may be dispersed and mixed in the raw material of the working electrode binder 214, and may be attached to the working electrode base material 211 by impregnation, application, or the like. Thereafter, the raw material of the working electrode binder 214 can be gelled or solidified under predetermined conditions such as a specific pressure, a specific temperature, and a specific time at which the raw material of the working electrode binder 214 can be gelled or solidified.

As shown in FIG. 5, the working electrode binder 214 is fixed by entering into a hole or a gap of unevenness formed in the surface of the working electrode base material 211. The working electrode binder 214 can generate a mechanical bonding force between itself and the working electrode base material 211 by an anchoring effect.

In the present embodiment, an ionic liquid gel obtained by gelating an ionic liquid is used as the working electrode binder 214. The ionic liquid gel is a gel-like structure in which an ionic liquid is held in a polymer network structure. By using the ionic liquid gel as the working electrode binder 214, the CO₂ adsorbent 212 and the working electrode binder 214 are easily brought into contact with each other, and the conductivity can be improved.

As the ionic liquid gel, a structure disclosed in JP 2015-25056 A can be used. In this structure, ionic liquid is held in a three-dimensional network structure composed of two different types of polymer chains. The three-dimensional network structure includes a first network structure formed by condensation polymerization and a second network structure formed by radical polymerization.

As a monomer to be subjected to condensation polymerization, tetraethoxy orthosilicate (TEOS) can be used. TEOS also functions as a crosslinking agent in condensation polymerization.

As a monomer to be subjected to radical polymerization, N,N-dimethylacrylamide (DMAAm) can be used. In the radical polymerization, N,N′-methylenebisacrylamide (MBAA) can be used as a crosslinking agent. In the radical polymerization, 2,2′-azobis (isobutyronitrile) (AIBN) can be used as an initiator.

The ionic liquid constituting the ionic liquid gel functions as a solvent for the monomer constituting the first network structure and the monomer constituting the second network structure. Then, after the first network structure and the second network structure are formed, the first network structure and the second network structure are entangled with each other, and the ionic liquid is included in these network structures.

As the ionic liquid constituting the ionic liquid gel, 1-ethyl-3-methylimidazolium bis (trifluoromethanesulfonyl) imide ([EMIM] [Tf₂N]), 1-butyl-3-methylimidazolium bis (trifluoromethanesulfonyl) imide ([BMIM] [Tf₂N]), 1-butyl-3-methylimidazolium tetrafluoroborate ([BMIM] [BF₄]), or the like can be used.

In order to impart hydrophobicity to the working electrode binder 214, it is desirable to use a hydrophobic ionic liquid as the ionic liquid constituting the ionic liquid gel. As the hydrophobic ionic liquid, [EMIM] [Tf₂N] or [BMIM] [Tf₂N] can be used.

The ionic liquid gel of the present embodiment can be obtained by independently proceeding the condensation polymerization of the monomer (for example, TEOS) constituting the first network structure and the radical polymerization of the monomer (for example, DMAAm) constituting the second network structure in the ionic liquid. The method for producing an ionic liquid gel of the present embodiment includes a step of mixing a monomer constituting a first network structure and a monomer constituting a second network structure into an ionic liquid, a step of forming the first network structure by condensation polymerization, and a step of forming the second network structure by radical polymerization. The radical polymerization may be performed after the condensation polymerization, or the condensation polymerization and the radical polymerization may be simultaneously performed.

The counter electrode 220 shown in FIG. 3 has the same configuration as the working electrode 210. That is, the counter electrode 220 includes a counter electrode base material 221, a counter electrode active material 222, a counter electrode conductive additive 223, and a counter electrode binder 224.

The counter electrode base material 221 is a conductive material. The counter electrode base material 221 may be made of the same material as the working electrode base material 211 or a different material may be used.

The counter electrode active material 222 is an auxiliary electroactive species having an opposite oxidation-reduction state to the CO₂ adsorbent 212 and exchanging electrons with the CO₂ adsorbent 212. The counter electrode active material 222 may be, for example, a metal complex that can receive and release electrons by changing a valence of a metal ion. Examples of the metal complex include cyclopentadienyl metal complexes such as ferrocene, nickelocene, and cobaltocene, porphyrin metal complexes, and the like. In the present embodiment, polyvinyl ferrocene shown below is used as the counter electrode active material 222.

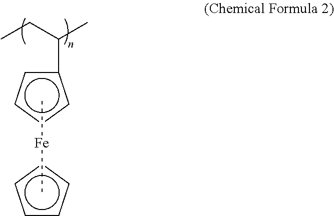

The counter electrode conductive additive 223 is a conductive material that forms a conductive path to the counter electrode active material 222. The counter electrode conductive additive 223 is used by being mixed with the counter electrode active material 222. In FIG. 3, the counter electrode conductive additive 223 is illustrated as being separated from the counter electrode active material 222, but the counter electrode conductive additive 223 is actually in contact with the counter electrode active material 222.

The counter electrode conductive additive 223 is a metal oxide having a structure in which an oxygen element is disposed around a metal element. As the counter electrode conductive additive 223, the same material as the working electrode conductive additive 213 may be used, or a different material may be used. The counter electrode conductive additive 223 is, for example, in the form of particles.

The counter electrode binder 224 may be any material which can hold the counter electrode active material 222 and the counter electrode conductive additive 223 on the counter electrode base material 221 and has conductivity. As the counter electrode binder 224, the same material as the working electrode binder 214 may be used, or a different material may be used.

The insulating layer 230 is disposed between the working electrode 210 and the counter electrode 220. The insulating layer 230 separates the working electrode 210 from the counter electrode 220. The insulating layer 230 prevents physical contact between the working electrode 210 and the counter electrode 220. In addition, the insulating layer 230 suppresses an electrical short circuit between the working electrode 210 and the counter electrode 220.

As the insulating layer 230, a separator or a gas layer such as air can be used. In the present embodiment, a porous separator is used as the insulating layer 230. As the material of the separator, a separator made of a cellulose film, a polymer, a composite material of a polymer and a ceramic, or the like can be used.

The ion conductive member 240 is provided between the working electrode 210 and the counter electrode 220. Specifically, the ion conductive member 240 is provided between the working electrode base material 211 and the counter electrode base material 221 with the insulating layer 230 interposed therebetween.

The ion conductive member 240 is in contact with the CO₂ adsorbent 212 inside the working electrode base material 211. The ion conductive member 240 has ion conductivity. Accordingly, the ion conductive member 240 promotes conduction to the CO₂ adsorbent 212. The ions contained in the ion conductive member 240 do not directly react with the functional group bonded to CO₂ contained in the CO₂ adsorbent 212.

A non-fluid substance having no fluidity can be used as the ion conductive member 240. Examples of the non-fluid substance include a gel substance and a solid substance. As the non-fluid substance, for example, an ionic liquid gel, a solid electrolyte, or the like can be used. The ion conductive member 240 may be made of the same material as the working electrode binder 214, or may be made of a different material from the working electrode binder 214. As described above, by using a non-fluid substance as the ion conductive member 240, it is possible to suppress elution of the ion conductive member 240 from between the working electrode 210 and the counter electrode 220.

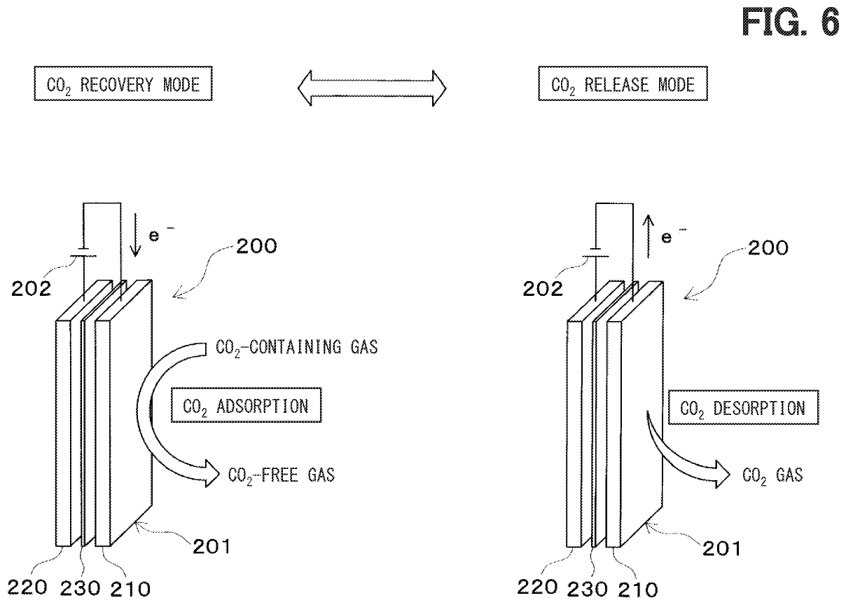

Next, the operation of the carbon dioxide recovery system 1 will be described. As shown in FIG. 6, the carbon dioxide recovery system 1 alternately switches between the CO₂ recovery mode and the CO₂ release mode. The carbon dioxide recovery system 1 is controlled by the control device 500.

First, the CO₂ recovery mode will be described. In the CO₂ recovery mode, the compressor 100 operates and the CO₂ containing gas is supplied to the CO₂ recovery device 200. In the CO₂ recovery device 200, a voltage applied between the working electrode 210 and the counter electrode 220 is set as a first voltage. Thus, electron donation by the counter electrode active material 222 of the counter electrode 220 and electron withdrawal by the CO₂ adsorbent 212 of the working electrode 210 can be realized at the same time.

When a voltage is applied between the working electrode 210 and the counter electrode 220, the counter electrode active material 222 of the counter electrode 220 releases electrons to be in an oxidized state, and the electrons are supplied from the counter electrode 220 to the working electrode 210. The CO₂ adsorbent 212 of the working electrode 210 receives electrons and enters a reduced state.

The CO₂ adsorbent 212 in the reduced state has a high binding force of CO₂ and binds and adsorbs CO₂ contained in the CO₂ containing gas. In this way, in the electrochemical cell 201, when a voltage is applied between the working electrode 210 and the counter electrode 220, electrons are supplied from the counter electrode 220 to the working electrode 210, and the CO₂ adsorbent 212 combines with CO₂ as the electrons are supplied. Therefore, the CO₂ recovery device 200 can recover CO₂ from the CO₂ containing gas.

After the CO₂ of the CO₂ containing gas is recovered by the CO₂ recovery device 200, the CO₂-free gas not containing CO₂ is discharged from the CO₂ recovery device 200. In the flow path switching valve 300, the gas flow path is switched to the atmosphere side. Therefore, the CO₂-free gas discharged from the CO₂ recovery device 200 is released to the atmosphere.

Next, the CO₂ release mode will be described. In the CO₂ release mode, the compressor 100 is stopped, and the supply of the CO₂ containing gas to the CO₂ recovery device 200 is stopped. In the CO₂ recovery device 200, the voltage applied between the working electrode 210 and the counter electrode 220 is set as the second voltage. Accordingly, electron donation by the CO₂ adsorbent 212 of the working electrode 210 and electron withdrawal by the counter electrode active material 222 of the counter electrode 220 can be realized at the same time.

The CO₂ adsorbent 212 of the working electrode 210 emits electrons and becomes an oxidized state. In the CO₂ adsorbent 212, the binding force of CO₂ decreases, and CO₂ is desorbed and released. The counter electrode active material 222 of the counter electrode 220 receives electrons and enters a reduced state.

The CO₂ released from the CO₂ adsorbent 212 is discharged from the CO₂ recovery device 200. In the flow path switching valve 300, the gas flow path is switched to the CO₂ utilization device 400. Therefore, the CO₂ discharged from the CO₂ recovery device 200 is supplied to the CO₂ utilization device 400.

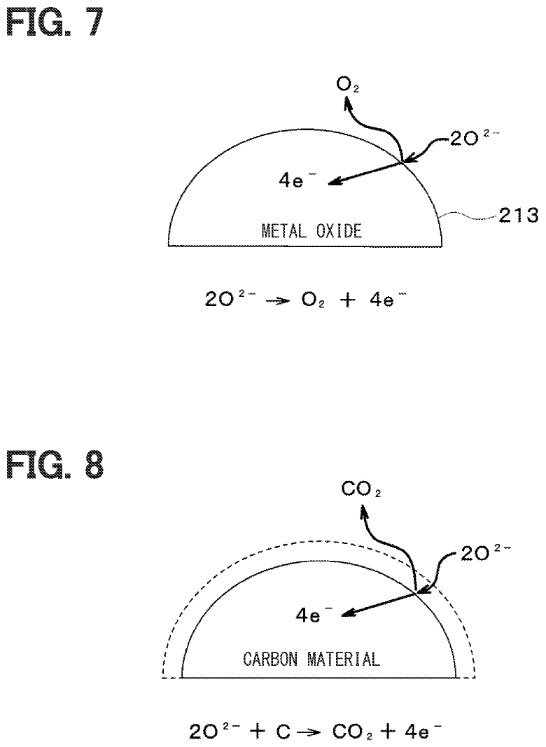

As described above, in the present embodiment, the working electrode 210 includes the working electrode conductive additive 213. The working electrode conductive additive 213 is a metal oxide containing no carbon. In the metal oxide, an oxygen element is already bonded around the metal element. Therefore, as shown in FIG. 7, the reaction between the substance containing oxygen in the CO₂ containing gas and the working electrode conductive additive 213 does not occur. The substance containing oxygen generates O²⁻ by an electric field reaction of oxygen contained in the CO₂ containing gas when a negative voltage is applied to the electrochemical cell 201. Therefore, an example of the reaction between the substance containing oxygen and the working electrode conductive additive 213 is 2O²⁻→O₂+4e⁻.

As described above, since the reaction between the material containing oxygen contained in the CO₂ containing gas and the working electrode conductive additive 213 does not occur and only oxygen is generated, the working electrode conductive additive 213 is not consumed by the material containing oxygen. That is, the working electrode 210 is not consumed. The conductivity of the working electrode conductive additive 213 is maintained. The same applies to the counter electrode conductive additive 223 of the counter electrode 220. Therefore, it is possible to suppress the generation of the organic gas on both of the working electrode 210 and the counter electrode 220.

By suppressing the generation of the organic gas, the recovery purity of CO₂ can be improved. In addition, since the recovery purity of CO₂ with respect to the energy used for recovering CO₂ is improved, the energy efficiency can be improved. Further, since the working electrode 210 and the counter electrode 220 are not consumed due to the reaction with the substance containing oxygen, the repetition durability of the working electrode 210 and the counter electrode 220 can be improved.

As a comparative example, when the working electrode conductive additive 213 is a carbon material, as shown in FIG. 8, a reaction occurs between a substance containing oxygen in the CO₂ containing gas and the working electrode conductive additive 213. An example of the reaction between the substance containing oxygen and the working electrode conductive additive 213 is 2O²⁻+C→CO₂+4e⁻. As described above, since the carbon of the working electrode conductive additive 213 is used for the reaction, the working electrode conductive additive 213 is consumed. That is, the amount of the working electrode conductive additive 213 is reduced. Therefore, the conductivity of the working electrode conductive additive 213 decreases.

As a modification, the counter electrode 220 may not include the counter electrode conductive additive 223. Alternatively, the counter electrode 220 may contain a conductive additive different from the counter electrode conductive additive 223.

### Second Embodiment

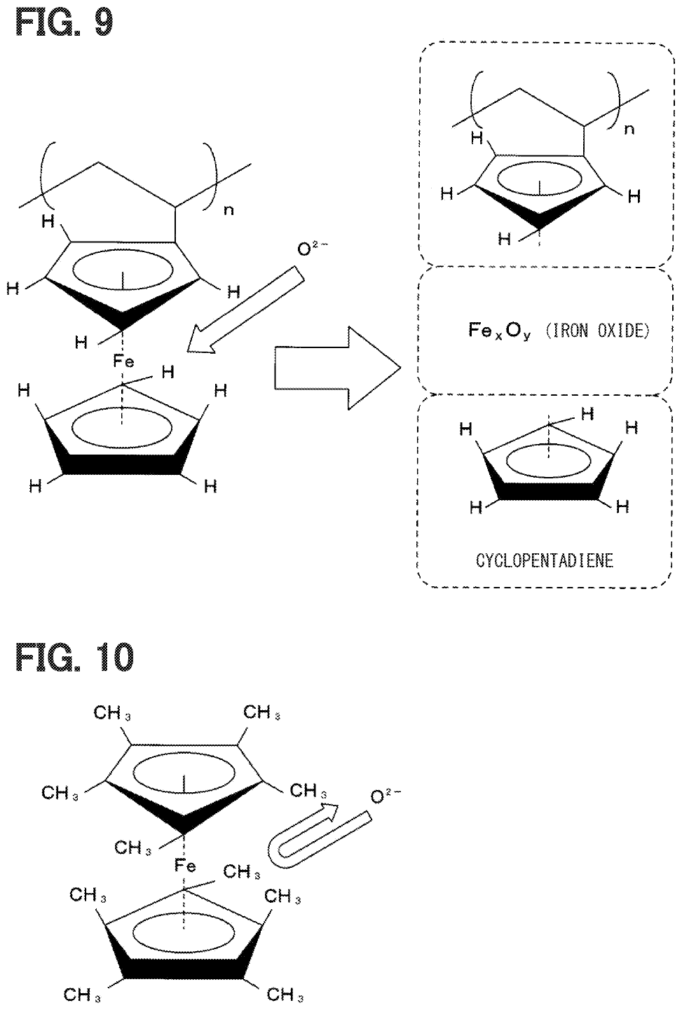

In the present embodiment, the configurations different from those of the first embodiment will be mainly described. As shown in FIG. 9, when the counter electrode active material 222 is polyvinylferrocene, since Fe is a reaction site, there is a possibility that Fe in the polyvinylferrocene and O²⁻ cause a decomposition reaction due to a substance containing oxygen. Thus, iron oxide and cyclopentadiene may be produced.

Therefore, in the present embodiment, a substance in which a functional group is modified at the apex of the five-membered ring constituting the cyclopentadienyl metal complex is employed as the counter electrode active material 222. Specifically, the counter electrode active material 222 is decamethylferrocene in which a methyl group is modified at the apex of a five-membered ring constituting ferrocene which is a cyclopentadienyl metal complex.

The counter electrode active material 222 is a stable active material that does not undergo a chemical reaction other than a main reaction with a gas species other than CO₂ in the atmosphere. The counter electrode active material 222 is a stable active material that does not undergo a chemical reaction other than a main reaction with an electrode member other than the counter electrode active material 222 in the counter electrode 220.

According to this, as shown in FIG. 10, since the functional group becomes steric hindrance, it is difficult for the substance containing oxygen to physically approach Fe constituting decamethylferrocene. Therefore, the decomposition reaction of decamethylferrocene by a substance containing oxygen is suppressed. Therefore, the generation of the organic gas can be suppressed.

As a modification, the counter electrode active material 222 is not limited to decamethylferrocene. For example, the distance between C and H at the apex of the five-membered ring may be long. Alternatively, a benzene ring may be attached to the apex of the five-membered ring.

### Third Embodiment

In the present embodiment, the description primarily focuses on the portions that differ from the first and second embodiments. In the present embodiment, the counter electrode active material 222 is a material in which the sulfur element is substituted with an element different from the sulfur element in the heterocyclic compound in which benzene rings are fused at both ends of thiazine containing the sulfur element and the nitrogen element.

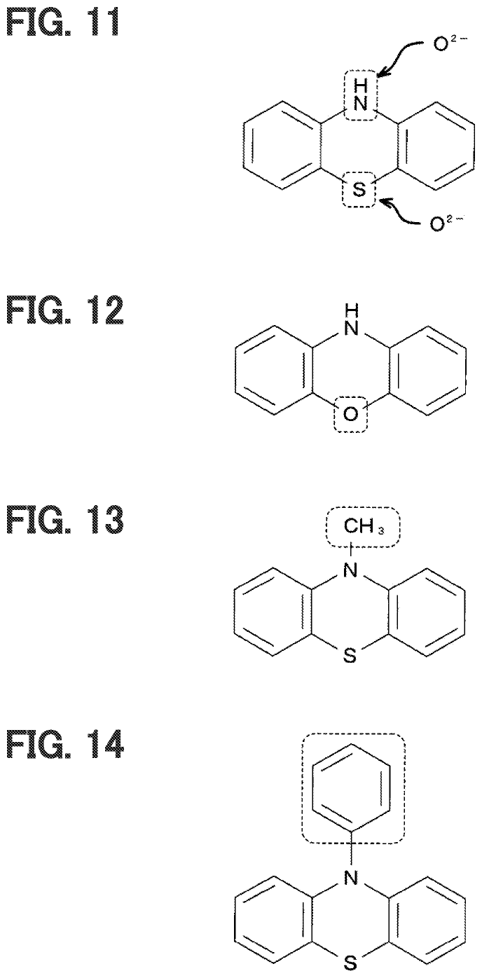

As shown in FIG. 11, the heterocyclic compound in which benzene rings are condensed at both ends of thiazine containing a sulfur element and a nitrogen element is phenothiazine. In phenothiazine, —N—H and S are reaction sites and likely to react with O²⁻. Therefore, in the present embodiment, as shown in FIG. 12, the sulfur element in the phenothiazine is substituted with the oxygen element. That is, the counter electrode active material 222 is phenoxazine.

In this manner, the structural stability of the counter electrode active material 222 can be enhanced by substituting a part of the elements of the phenothiazine. Therefore, the reaction between the substance containing oxygen contained in the CO₂ containing gas and the counter electrode active material 222 can be suppressed. Therefore, the generation of the organic gas can be suppressed.

As a modification, a substance in which a functional group is modified with a nitrogen element of phenothiazine may be employed as the counter electrode active material 222. As shown in FIG. 13, for example, the counter electrode active material 222 is methylphenothiazine in which a methyl group is modified on a nitrogen element of a heterocyclic compound. Alternatively, as shown in FIG. 14, the counter electrode active material 222 is phenylphenothiazine in which a phenyl group is modified on a nitrogen element of phenothiazine.

### Fourth Embodiment

In the present embodiment, portions different from those of the first to third embodiments will be mainly described. In the present embodiment, the voltage applied between the working electrode 210 and the counter electrode 220 is higher than −0.9 V and lower than 0 V. Note that the voltage condition is adopted in one or both of the CO₂ recovery mode and the CO₂ release mode.

As described above, O²⁻ is generated by applying a negative voltage to the electrochemical cell 201. The specific electric field reaction is O₂+2e⁻→2O²⁻. The inventors of the present disclosure have found through experiments that the above-described electric field reaction occurs when the voltage applied to the electrochemical cell 201 is −0.9 V or less, but the above-described electric field reaction is less likely to occur within a voltage range of more than −0.9 V and less than 0 V.

Therefore, by setting the voltage applied to the electrochemical cell 201 within the voltage range, it is possible to suppress the generation of O²⁻ that easily reacts with the working electrode conductive additive 213, the counter electrode conductive additive 223, and the counter electrode active material 222. Therefore, it is possible to further suppress the generation of the organic gas on both of the working electrode 210 and the counter electrode 220.

The present disclosure is not limited to the above-described embodiments, and can be variously modified as follows within the scope that does not deviate from the gist of the present disclosure.

For example, the compressor 100 is disposed upstream of the CO₂ recovery device 200, but the compressor 100 may be disposed downstream of the CO₂ recovery device 200.

In the above embodiment, each of the working electrode 210, the counter electrode 220, and the insulating layer 230 of the electrochemical cell 201 is a plate member, but may be a cylindrical member. In this case, the working electrode 210 may be disposed on the innermost side, the counter electrode 220 may be disposed on the outermost side, and the insulating layer 230 may be disposed between the working electrode 210 and the counter electrode 220. Thus, the space formed inside the working electrode 210 can serve as a gas flow path through which the CO₂ containing gas passes.

In the above embodiment, the working electrode binder 214 having hydrophobicity is used, but the working electrode binder 214 may not necessarily have hydrophobicity.

In the above embodiment, the working electrode binder 214 that selectively transmits CO₂ is used, but the working electrode binder 214 may not necessarily have CO₂ selective permeability.

In the above embodiment, the CO₂ adsorbent 212 is disposed inside the working electrode binder 214, but the CO₂ adsorbent 212 may be disposed on the surface of the working electrode binder 214. In this case, since the CO₂ adsorbent 212 can be in direct contact with the CO₂ containing gas, the working electrode binder 214 does not necessarily have CO₂ permeability.

Although the present disclosure has been made in accordance with the embodiments, it is understood that the present disclosure is not limited to such embodiments and structures. The present disclosure encompasses various modifications and variations within the scope of equivalents. In addition, while the various elements are shown in various combinations and configurations, which are exemplary, other combinations and configurations, including more, less or only a single element, are also within the spirit and scope of the present disclosure.

What is claimed is:

1. A carbon dioxide recovery system configured to separate CO₂ from a CO₂ containing gas containing CO₂ by an electrochemical reaction, the carbon dioxide recovery system comprising:
an electrochemical cell including a working electrode and a counter electrode, the working electrode having a CO₂ adsorbent that adsorbs the CO₂, wherein electrons are supplied from the counter electrode to the working electrode by applying a voltage between the working electrode and the counter electrode, and the CO₂ adsorbent combines with the CO₂ as electrons are supplied,
the working electrode includes a working electrode conductive additive that forms a conductive path to the CO₂ adsorbent, and
the working electrode conductive additive is a metal oxide having a structure in which an oxygen element is disposed around a metal element.

2. The carbon dioxide recovery system according to claim 1, wherein
the counter electrode includes a counter electrode active material that emits electrons when a voltage is applied between the working electrode and the counter electrode, and a counter electrode conductive additive that forms a conductive path to the counter electrode active material, and
the counter electrode conductive additive is a metal oxide having a structure in which an oxygen element is disposed around a metal element.

3. The carbon dioxide recovery system according to claim 1, wherein the metal oxide is ruthenium oxide or manganese dioxide.

4. The carbon dioxide recovery system according to claim 1, wherein
the counter electrode includes a counter electrode active material that emits electrons when a voltage is applied between the working electrode and the counter electrode, and
the counter electrode active material is a substance in which a functional group is modified at an apex of a five-membered ring constituting a cyclopentadienyl metal complex.

5. The carbon dioxide recovery system according to claim 4, wherein the counter electrode active material is decamethylferrocene in which a methyl group is modified at an apex of the five-membered ring constituting ferrocene which is the cyclopentadienyl metal complex.

6. The carbon dioxide recovery system according to claim 1, wherein
the counter electrode includes a counter electrode active material that emits electrons when a voltage is applied between the working electrode and the counter electrode, and
the counter electrode active material is a substance in which a sulfur element is substituted with an element different from the sulfur element or a functional group is modified at a nitrogen element, in a heterocyclic compound in which benzene rings are fused at both ends of thiazine containing the sulfur element and the nitrogen element.

7. The carbon dioxide recovery system according to claim 6, wherein the counter electrode active material is phenoxazine in which the sulfur element in the heterocyclic compound is substituted with an oxygen element.

8. The carbon dioxide recovery system according to claim 6, wherein the counter electrode active material is methylphenothiazine in which a methyl group is modified to the nitrogen element in the heterocyclic compound.

9. The carbon dioxide recovery system according to claim 6, wherein the counter electrode active material is phenylphenothiazine in which a phenyl group is modified to the nitrogen element in the heterocyclic compound.

10. A carbon dioxide recovery system configured to separate CO₂ from a CO₂ containing gas containing CO₂ by an electrochemical reaction, the carbon dioxide recovery system comprising:
an electrochemical cell including a working electrode and a counter electrode, the working electrode having a CO₂ adsorbent that adsorbs the CO₂, wherein electrons are supplied from the counter electrode to the working electrode by applying a voltage between the working electrode and the counter electrode, and the CO₂ adsorbent combines with the CO₂ as electrons are supplied,
the counter electrode includes a counter electrode active material that emits electrons when a voltage is applied between the working electrode and the counter electrode, and
the counter electrode active material is a substance in which a functional group is modified at an apex of a five-membered ring constituting a cyclopentadienyl metal complex.

11. The carbon dioxide recovery system according to claim 10, wherein the counter electrode active material is decamethylferrocene in which a methyl group is modified at an apex of the five-membered ring constituting ferrocene which is the cyclopentadienyl metal complex.

12. A carbon dioxide recovery system configured to separate CO₂ from a CO₂ containing gas containing CO₂ by an electrochemical reaction, the carbon dioxide recovery system comprising:
an electrochemical cell including a working electrode and a counter electrode, the working electrode having a CO₂ adsorbent that adsorbs the CO₂, wherein electrons are supplied from the counter electrode to the working electrode by applying a voltage between the working electrode and the counter electrode, and the CO₂ adsorbent combines with the CO₂ as electrons are supplied,
the counter electrode includes a counter electrode active material that emits electrons when a voltage is applied between the working electrode and the counter electrode, and
the counter electrode active material is a substance in which a sulfur element is substituted with an element different from the sulfur element, or a functional group is modified to a nitrogen element, in a heterocyclic compound in which benzene rings are fused at both ends of a thiazine containing the sulfur element and the nitrogen element.

13. The carbon dioxide recovery system according to claim 12, wherein the counter electrode active material is phenoxazine in which the sulfur element of the heterocyclic compound is substituted with an oxygen element.

14. The carbon dioxide recovery system according to claim 12, wherein the counter electrode active material is methylphenothiazine in which a methyl group is modified to the nitrogen element of the heterocyclic compound.

15. The carbon dioxide recovery system according to claim 12, wherein the counter electrode active material is phenylphenothiazine in which a phenyl group is modified to the nitrogen element of the heterocyclic compound.

16. The carbon dioxide recovery system according to claim 1, wherein a voltage applied between the working electrode and the counter electrode is within a range greater than −0.9 V and less than 0 V.
